(19) United States
(12) Patent Application Publication
(10) Pub. No.: US 2022/0236977 A1
(43) Pub. Date: Jul. 28, 2022

(54) SYSTEM AND METHOD FOR ANALYZING FIRST PARTY DATA FROM ONE OR MORE SOFTWARE TOOLS

(71) Applicant: SQOR Technologies Inc., New York, NY (US)

(72) Inventors: Lazaro Fuentes, New York, NY (US); Muhammad Harris, Rawalpindi (PK); Muhammad Haris Bin Naeem, Islamabad (PK)

(21) Appl. No.: 17/581,404

(22) Filed: Jan. 21, 2022

Related U.S. Application Data
(60) Provisional application No. 63/140,460, filed on Jan. 22, 2021.

(51) Int. Cl. G06F 8/65; G06F 8/61; G06F 8/76; G06F 8/77

(52) U.S. Cl. CPC G06F 8/65; G06F 8/77; G06F 8/76; G06F 8/61

(57) ABSTRACT

Technologies for retrieving first party data from external sources and generating an entity execution score is provided. The disclosed techniques include joining a cloud-based software application, signing into the cloud-based software application, and requesting certain company related information. The disclosed techniques may further comprise the steps of selecting a company industry vertical, selecting a company funding stage, and providing relevant licensed software tools to be selected. The disclosed techniques may further comprise selecting at least one licensed software tool, integrating the at least one licensed software tool into the cloud-based software application, and initiating a return of data related to a key performance indicator using a company's own, or first party data from the at least one licensed software tool. An execution score is algorithmically computed based in part on at least one key performance indicator data.

### CROSS REFERENCE TO RELATED APPLICATIONS; PRIORITY CLAIM

The application claims benefit to Provisional Application 63/140,460, filed on Jan. 22, 2021, the entire contents of which is hereby incorporated by reference as if fully set forth herein, under 35 U.S.C. § 119(e).

### TECHNICAL FIELD

The present disclosure relates generally to retrieving first-party data from one or more software tools used by an entity and assigning an entity quality score to the entity based upon analyzing the first-party data retrieved from the one or more software tools.

### BACKGROUND

Steady access to high-quality deals can be important for a venture investor to succeed. Without healthy deal flow, a venture investor may miss out on high-profile investment rounds and therefore might fail to make high returns. Traditionally, venture investors have relied on their network of relationships to connect to promising young companies, and their decisions to move forward to do a meeting and subsequently on to due diligence on a potential investment are often based on chance recommendations, gut feelings after seeing a public presentation, and investor instincts. Increasingly, this status quo of traditional investment pre-qualification methodologies of venture investors, whether angel investors, accelerators, or venture capital investors, has left much to be desired.

Above all, venture investment is often plagued by persistent gender, race, age, geographic, sexual preference and other arbitrary biases limiting an investor's access to deals and deal flow opportunities because of the loss of opportunity that is a result of such limitations in thinking and qualification. For example, since 2015, only 2.4 percent of total U.S. venture capital raised was done so by Black and Latinx founders in the U.S., which may be perceived as a very low percentage given that they represent approximately 40% of the total US population. The persistence of these biases speaks more about a status quo that needs to change in the area of deal flow sourcing. Even as discussions heat up from time to time throughout the venture funding community about these persistent problem's and many similar efforts are rolled out each time to help improve them, the reality is that none of them get at the fundamental problem in any scalable way. The discussions and the efforts make everyone feel good about themselves for a while, but the results rarely change much at all.

A common method of receiving attention from venture investors is for a company to make it through what, for lack of a better term, can be called the “PPP” gates; public presentations, public pitch, and public relations. Oftentimes, this attention may be achieved either through word of mouth in one's network, or from the press. Investors acting as gatekeepers have relied on these as their main method of ferreting out whether a company is a promising opportunity worthy of their attention and possible investment, or not.

If a company makes it through the gates, it warrants moving on to more time-consuming and more expensive first-party data due diligence. As this term is used herein, first party data is data that is taken or extracted from business software commonly used in the various divisions of a company. This last gate may be the most important, but because it was unrealistic to perform due diligence on every company it is left for last, after the collection of arbitrary measures have been exhausted. As can be expected, once a company goes through due diligence of first-party data, the results can lead to an even greater loss of investment opportunities available as the showmanship often gives way to the reality of poor execution. This has been the way that the system has worked until now.

With the convergence of broadband speeds, cloud computing capabilities, and the explosion of the business software as a service (“SaaS”) model, allowing for many of the quantitative and operational aspects of a company to be digitized even at the earliest stages of a company, venture investors now have an opportunity to change the way that they do things and expand their access to quality deal flow. This can be achieved while reducing many of the persistent bias that can typically arise during the venture funding phases. The missing ingredient is unbiased, first-party execution data, scored or evaluated in such a way that does not require direct disclosure of a company's information, but that comes from directly scoring that data via integrations.

Machine learning and AI applied to the first-party data in a company's stack of SaaS tools, utilized at the earliest stages of company development and ongoing, can efficiently and quickly paint a picture of a company's ability to execute. Scoring that execution data early can provide a way to pre-qualify or have pre-due diligence performed before choosing who gets to proceed to the “PPP” gates, or the arbitrary, portions of the selection process. This flipping of the investment criteria to be data-driven first, centered on an execution score, has the potential to increase the health of an investor's pipeline of deals. In addition, gathering such investment criteria at an initial stage of an investigation can also allow investors to monitor the health of their existing portfolio companies in real-time to address issues early. Such a cloud-based software system and methods may also save the venture investor valuable time, trouble, and treasure. Moreover, such a cloud-based software system and methods may also allow for investments that are unbiased and inclusive, rewarding high execution scores as a driver of attention and investment from investors.

### SUMMARY

According to an embodiment, a method of generating a company execution score is disclosed. The method comprises the steps of joining a cloud based software application, signing into the cloud based software application, and requesting certain company related information. The method further comprises the steps of selecting a company industry vertical, selecting a company funding stage, providing relevant licensed software tools to be selected, selecting at least one licensed software tool, and integrating the at least one licensed software tool into the cloud-based software application. The method may further comprise the steps of initiating a return of data related to a key performance indicator using a company's own, or first party data from the at least one licensed software tool and algorithmically computing an execution score based in part on at least one key performance indicator data.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

In the drawings:

FIG. 1 is a block diagram that depicts a system 100 for analyzing first party data from software tools of an entity and generating an entity execution score, in an embodiment.

FIG. 2 depicts an example flowchart for calculating an entity execution score based upon performance data received from one or more external software tools, in an embodiment.

FIG. 3 is a block diagram that illustrates a computer system upon which an embodiment of the invention may be implemented.

FIGS. 4A-4C depict another example flowchart depicting a standard for quantitative operational rating system calculating the entity execution score, in an embodiment.

FIGS. 5A-5C depicts another example flowchart depicting the standard for quantitative operational rating system initializing parameters and variables, calculating the entity execution score, and generating notifications for user devices, in an embodiment.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Therefore, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Therefore, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Analysts who research entities, such as companies, lack a cost effective and efficient method and/or system to monitor the health of their pipeline of entities. As such, analysts may miss certain potentially valid investment opportunities as a result. Sourcing deals can be costly and/or time consuming, especially when the traditional pool of potential investments is restricted or limited. Accurately keeping track of the health of the investments and reporting back to the limited partners can be difficult and time consuming. Many company founders, especially underrepresented groups based on gender, race, geography, age, etc., may be excluded. Consequently, such underrepresented groups may miss out on equal, fair, and potentially unbiased access to funding as a result of the outdated methods of choosing which ventures to allocate attention to, and ultimately select for funding.

There are few ways to definitively demonstrate your ability as a company founder to execute and succeed, while bypassing the inherent biases in the industry. Real-time insights on a private company's health are difficult to acquire until after a long and drawn out selection process. Founders need a single and reliable metric to provide these insights. Similarly, venture investors need a similar or same metric to bring the investment candidate selection process into the twenty-first century, expand their access to quality deal flow, and to do so in an unbiased way.

### System Overview

In an embodiment, a standard for quantitative operational rating (SQOR) system may be implemented to analyze one or more performance metrics of an entity, in order to determine the health of the entity. For example, if the entity is a company, then the SQOR system may be used to analyze various company performance metrics in order to determine the health of the company. The SQOR system may generate an entity execution score that represents the company's overall health.

In order to accurately determine an entity's health using an entity execution score, the SQOR system classifies entities based upon the maturity of the entity, using entity attributes such as the entity's current funding stage as a startup, and the industry within which the entity operates. An entity may have several different divisions, departments, or subgroups that make up the entity. For example, if the entity represents a company, then the entity may include several different divisions, such as sales, Sales, Marketing, Customer Success, Product & Engineering, Operations, Finance. Each of these divisions may have one or more performance measurables, represented by one or more performance metrics and/or key performance indicators (KPIs).

For the purposes of this disclosure, a vertical, herein represents a specific industry or sector within which an entity operates. Examples of verticals may include, but are not limited to, e-commerce, financial technology (FinTech), health technology (HealthTech), software as a service (SaaS), and any other industry. For the purposes of this disclosure, a stage herein represents a stage of maturity of an entity. For example, if the entity is a startup company, then the stages of the entity may represent different company stages of a startup such as a seed funding stage, a series A funding stage, a series B funding stage, and so on.

The SQOR system, may be configured to retrieve performance metrics from various external software tools used and integrated by the entity. For example, an entity that represents an e-commerce company may utilize various SaaS tools such as Salesforce™, Mixpanel™, Zendesk™, Quickbooks™, provided by external services. Each of these tools may generate performance metrics such as KPIs that may be used to evaluate performance of a specific aspect of the entity. For example, KPIs generated from a sales tool may be used to evaluate the performance of the sales department. If sales KPIs indicate that the percentage of customer conversions for a period of a week has increased from the previous week then the KPIs would indicate an increase in performance for the sales department.

In an embodiment, the SQOR system may retrieve performance metrics for each of the external tools integrated by the entity. Each of these performance metrics may be analyzed and scored for the purpose of determining an overall execution score for the entity. Each of the retrieved performance metrics may be assigned to a specific division within the entity. For instance, KPIs from external tools used by the sales department, are assigned to the sales division. Each of the divisions may then aggregate and score the assigned KPIs for each division. Each of the division scores may then be weighted based upon the importance of each division to the entity, with respect to the entity's vertical and stage. For example, if an entity is an e-commerce company (e-commerce vertical) that is in the initial seed stage, then scores corresponding to divisions such as Product and Engineering may be given greater weight than other divisions such as Sales. If, however the same entity is in the e-commerce vertical but is assigned to a series B funding stage, then the sales and research divisions may be given lesser weight than what was given when the entity was in the initial seed stage.

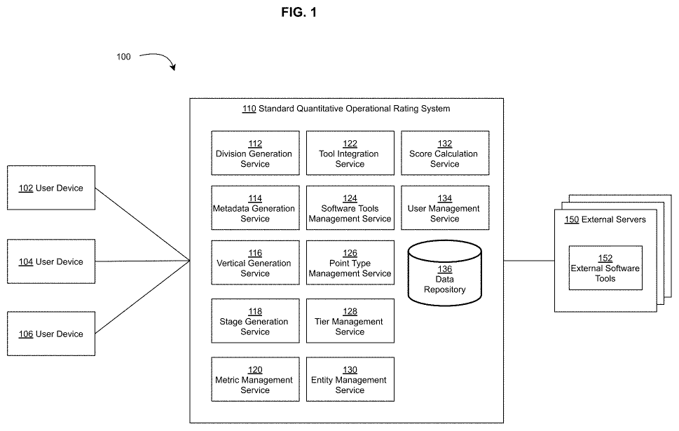

FIG. 1 is a block diagram that depicts a system 100 for analyzing first party data from software tools of an entity and generating an entity execution score, in an embodiment. An entity may represent a physical company, a portion of the company, such as a department or a group of departments, an organization, a group of users, or any other entity that performs a function or transacts with other entities.

The entity execution score may represent a quality measurement of the entity's business execution over a period of time. For example, if the entity is a startup business, then the entity execution score may represent a quality metric of how well the entity performs relative to other similar startup businesses that are at a similar startup stage as the entity analyzed. In other examples, where the entity represents a specific department within a company, such as the sales department, then the entity execution score for the sales department may represent the department's performance relative of other sales departments from similar companies. The entity execution score may be based on several different types of metrics and KPIs representing the performance of the entity. For instance, if the entity is the sales department of the company, then the entity execution score may be based on completed sales, new accounts, lost accounts, an increase or decrease in sales revenue, and any other KPIs related to the performance of the sales department.

In an embodiment, system 100 may include user devices 102-106, SQOR system 110, and externals servers 150. Although a single SQOR system 110 is depicted in system 100, system 100 may include additional SQOR systems 110. In an embodiment, user devices 102-106, SQOR system 110, and externals servers 150 may be communicatively coupled to each other by a network. The network may represent a communication medium or mechanism that provides for the exchange of data between A and B. An example of the network may include, but is not limited to, a network such as a Local Area Network (LAN), Wide Area Network (WAN), Ethernet or the Internet, or one or more terrestrial, satellite or wireless networks.

In an embodiment, the SQOR system 110 may be one or more computing devices (such as a rackmount server, a router computer, a server computer, a personal computer, a mainframe computer, a laptop computer, a tablet computer, a network connected television, a desktop computer, cloud server nodes, etc.), data stores (e.g., hard disks, memories, databases), networks, software components, and/or hardware components that may be used to analyze first party data, of an entity, from one or more external servers 150 and generate an entity execution score for a particular entity.

In an embodiment, the SQOR system 110 may include a division generation service 112, a metadata generation service 114, a vertical generation service 116, a stage generation service 118, a metric management service 120, a tool integration service 122, a software tools management service 124 a point type management service 126, a tier management service 128, an entity management service 130, a score calculation service 132, a user management service 134, and a data repository 136.

In an embodiment, the division generation service 112 is implemented to generate and assign relative weights to divisions for multiple different types of entities. For example, the division generation service 112 defines a set of divisions, such as sales, research, development, quality assurance, and customer service and their respective attributes. Each division may be assigned to multiple different stages and verticals, where depending on the stage and vertical, the division may be assigned a different weight. For instance, the sales division may be assigned a larger weight if the entity is in the initial seed stage and the entity belongs in the e-commerce vertical. The division generation server 112 may be configured to manage each of the weights assigned to each of the identified divisions based upon the entity's current stage and vertical.

In an embodiment, the metadata generation service 114 may be implemented to store and manage metadata related to how the score calculation service 132 scores each entity. For example, the metadata generation service 114 may determine a maximum score, for a particular entity, based upon one or more attributes associated with the entity and/or based upon other entities that may have similar characteristics to the entity, the current stage the entity is in, and the vertical assigned to the entity. For instance, an entity with 10 divisions may have a higher max score than an entity with only 3 divisions. Additionally, the maximum score for each division of the entity may be based on the particular stage the entity currently belongs to and the vertical assigned to the entity.

In an embodiment, the vertical generation service 116 may be implemented to define each of the verticals available for assignment. For example, the vertical generation service 116 may define and store attributes for defined verticals such as e-commerce, FinTech, HealthTech, SaaS, and any other industry. In an embodiment, the stage generation service 118 may be implemented to define each of the stages an entity may belong to. For example, stage generation service 118 may define and store attributes for all stages such as the initial seed stage, the series A funding stage, the series B funding stage, and so on.

In an embodiment, the metric management service 120 may be implemented to store and maintain values for the one or more performance metrics and/or one or more KPIs. For example, if an entity uses a SaaS tool for tracking online advertising conversions, the metric management service 120 is implemented to maintain a set of values, representing the one or more performance metrics, for the SaaS tool over multiple periods of time. The metric management service 120 may store the values in the data repository 136.

In an embodiment, the tool integration service 122 may be implemented to define which software tools have been integrated into an entity. For example, if a particular entity, representing a particular company, uses 5 different SaaS software tools, then the tool integration service 122 may keep track of each of the SaaS software tools assigned to the particular entity. If the particular entity stops using a specific SaaS software tool, then the tool integration service 122 may remove an association between that specific SaaS software tool and the particular entity. Similarly, if the particular entity begins integrating a new SaaS software tool, then the tool integration service 122 may add a new association between the new SaaS software tool and the particular entity.

In an embodiment, the software tools management service 124 may be implemented to store and manage attributes for each of the software tools integrated by entities. For example, the software tools management service 124 may store specific attributes for each software tool such as the tool name, configuration values, assigned divisions, and specific weights that may be assigned to the software tool based upon the specific vertical and stage of the entity. For instance, a particular software tool may be assigned a larger weight if the entity is in the e-commerce vertical than if the entity is in the healthcare vertical.

In an embodiment, the point type management service 126 may be implemented to collect and manage data retrieved from the external software tool 152 and identify different types of metrics based upon the type of behavior of the data retrieved. For instance, the point type management service 126 may identify whether data retrieved is an action, an event, or a point. Different point types may include, but are not limited to, utilization data that captures the utilization of the software tool, KPIs that capture the performance of the entity with a specific vertical from the software tool, and integration data that captures integration events from the software tool. For example, the point type management service 126 may determine that particular SaaS KPIs has a point scale ranging from −1, 0, and 1, which may represent bad, neutral, and good performance, respectively.

In an embodiment, the tier management service 128 may be implemented to define specific tiers for various software tools for the purposes of assigning different levels of importance to each software tool. For example, the tier management service 128 may be able to group software tools based on their level of importance, according to the current stage and vertical of the entity, and assign different weights to the software tools based on their respective tier.

In an embodiment, the entity management service 130 may be implemented to store and manage attributes of entities. For example, specific details for an entity, such as entity name, owner, vertical, and stage may be stored and managed by the entity management service 130. The entity management service 130 may also store configuration and integration information for each software tool integrated by the entity. The configuration and integration information may represent any and all information needed to connect to external servers 150 and external software tools 152 for the purposes of managing the software tools for a particular entity as well as to retrieve related performance metrics, such as KPIs from the external servers 150 and external software tools 152.

In an embodiment, the score calculation service 132 may be implemented to generate an entity execution score for a particular entity based upon weighted scores assigned to each of the received performance metrics over a particular period of time. The score calculation service 132 may be implemented to provide the calculated entity execution score as well as other entity specific details such as entity name, start and end date of the period analyzed, a list of each performance metric used in the calculation, their assigned points, and the weighting values used for each performance metric.

In an embodiment, the user management service 134 may be implemented to store attributes for the user interacting with the SQOR system 110. For example, the user management service 134 may store the user's name, contact information, user type, and any other relevant information. The user type may refer to whether the user interacting with the SQOR system 110 is an analyst, an entity founder, a supervisor, an investment partner, or any other user that may log into the SQOR system 110 or otherwise receive information from the SQOR system 110. In an embodiment, the data repository 136 may represent a data storage system configured to store data from services 112-134 on a data store such as a hard disk, memory, and/or databases.

In an embodiment, user devices 102-106 may represent computing devices including, but not limited to, desktop computers, laptop computers, tablet computers, wearable devices, video game consoles, smartphones, and any other computer. User devices 102-106 may represent devices users may use to receive notifications and initiate new user sessions on the SQOR system 110.

In an embodiment, the external servers 150 may represent one or more servers configured to implement external software tools 152. External software tools 152 may represent any such software tool implemented by an entity that provides one or more performance metrics to the SQOR system 110. Examples of external software tools 152 may include one or more cloud-based SaaS tools. As described herein, SaaS is a software licensing and delivery model wherein software is licensed on a subscription basis. Typically, such licensed software would be centrally hosted. Software as a service may also be referred to as “on-demand software” or “software plus services.” As those of ordinary skill in the art will recognize, SaaS applications are also known as Web-based software, on-demand software or hosted software. As those of ordinary skill will recognize, alternative descriptive terms may also be used.

SaaS, on-demand software, or software plus services, is becoming ever more common as a form of a software application that may be delivered over the internet and is being facilitated in a technology infrastructure called “Cloud Computing.” In this form of software application delivery, where the software application is controlled by a service provider, a customer may experience stability and data security issues. In many cases, the customer is a business organization that is using the SaaS for business purposes. i.e., business software hence, stability and data security are primary requirements.

One advantage of the presently disclosed systems and methods is its use of cloud computing. The term “cloud computing” as used herein in this disclosure, may be used to reference a technology infrastructure that facilitating supplement, consumption and delivery of IT services. Preferably, the IT services are internet based and involve provisioning of dynamically scalable and many a time virtualized resources. As such, one advantage of the presently disclosed systems and methods is that a cloud-based service where instead of downloading software your desktop PC or business network to run and update, you instead access an application via an internet browser.

Key advantages of SaaS includes accessibility, compatibility, and operational management. Additionally, SaaS models offer lower upfront costs than traditional software download and installation, making them more available to a wider range of businesses, making it easier for smaller companies to disrupt existing markets while empowering suppliers.

One advantage of any SaaS application is the ability to run through an internet browser, so it doesn't matter which Operating System is used to access it. So regardless as to whether the user is trying to run the application on Windows, Mac. or Linux machines (or even smartphones running Android or iOS), the application still remains accessible. This makes SaaS applications, such as the presently disclosed SQOR application, versatile in a couple of different ways.

The presently disclosed systems and methods may be utilized with one or more different type so SaaS tools. For example, exemplary SaaS tools that may be utilized with the presently disclosed systems and methods include at least the following types of tools: analytics, accounting software, eCommerce software, collaboration management, knowledge management software, human resources software, learning management, live chat, business intelligence, office software, time tracking, website builder, payment gateway, marketing software, sales software, Point Of Sale software, project management software, communications software, Customer Relationship Management, payroll, customer experience management, IT security software, pricing, survey software social media management, customer service, employee monitoring, retention, email marketing software, document and file management, content management, and appointment scheduling.

In an embodiment, SQOR provides a platform that allows for integration of the top cloud-based business software SaaS stack. This enables companies to connect their tools via established application programming interfaces (“API”).

The term “Application Programming Interface (API)” as used herein in this disclosure, is defined as an interface that a software program implements to allow a software to interact with it; much in the same way that software might implement a user interface in order to allow humans to interact with it. APIs are implemented by software applications, libraries, and operating systems to define how other software can make calls to or request services from them. An API determines the vocabulary and calling conventions that the programmer should employ in order to use the services. The API may include specifications for routines, data structures, object classes, and protocols used to communicate between a consumer and an implementer of the API.

Once the company connects their various tools, SQOR's algorithm tracks their historical and real-time performance data at regular intervals. SQOR calculates an execution score to the company based on that data, and any initial data entered into the SQOR platform by the company leadership. Once a company receives a score, they can utilize this ongoing algorithmic scoring system to gauge the quantitative and operational health of the company at any given time.

Investors are able to use a company's execution score as an automated system to pre-qualify and flag the company as a potentially interesting investment. As just one advantage of the presently disclosed automated system, this may be accomplished in an unbiased, data driven manner. By selecting companies to track, investors can monitor the health of the pipeline of potential investments and receive a score on the health of that pipeline. Additionally, investors can utilize SQOR's execution score to track the ongoing health of their portfolio investments individually, or as part of a particular fund, or cohort.

In an embodiment, each individual SAAS tool within a company division (i.e., sales, marketing, finance, operations, customer success, and engineering, etc. . . . ) may be assigned an execution score. These scores may then be combined and averaged to reach a division level score that can be used internally to monitor the health of a company division. These division level scores may then be combined and averaged to reach a company level execution score. Such an execution score may have many different types of uses. For example, such an execution score may be used as a north star metric by company founders seeking to improve operationally. Alternatively, such an execution score may be used by investors seeking quality, data-driven, and unbiased deals. Those of ordinary skill in the art will perceive other uses of such execution scores.

In conclusion, the software choices that a company founder makes early in a company's journey can help determine the likelihood of success in building and scaling the business. Certain software choices that seem simple in the early stages of a company (i.e., like selecting QuickBooks versus utilizing manual Excel bookkeeping) can either facilitate a successful operation or create hurdles/roadblocks as the company grows. As just another example, from an analytics standpoint, using SaaS tools like the analytics based ProfitWell Metrics to measure growth of new and existing users, and being able to benchmark against thousands of similar companies.

The choices of software by a company's division provide an opportunity to efficiently monitor the particular company division. Similarly, a combined divisional score of a company provide an overall execution score that can help pre-qualify a company as a potentially viable venture to invest in. The data that is generated from the tools that are chosen, or not chosen, can help to drive that determination in an unbiased, data-driven way.

### Functional Overview

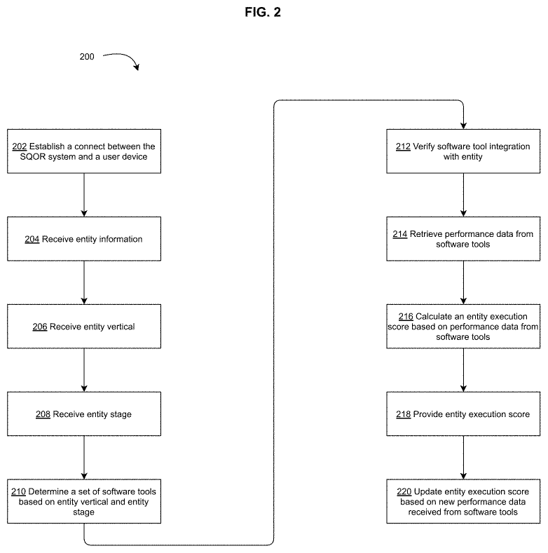

FIG. 2 depicts an example flowchart for calculating an entity execution score based upon performance data received from one or more external software tools. Process 200 may be performed by a single program or multiple programs. The operations of the process as shown in FIG. 2 may be implemented using processor-executable instructions that are stored in computer memory. For purposes of providing a clear example, the operations of FIG. 2 are described as performed by the SQOR system 110. For the purposes of clarity process 200 is described in terms of a single entity.

In operation 202, process 200 establishes a connection between SQOR system 110 and user device 102. In an embodiment, user device 102 may request to establish a connection with SQOR system 110. For example, a user using user device 102 may log into SQOR system 110. The SQOR system 110 may receive a login request from user device 102, authenticate the user, and establish a secure connection between SQOR system 110 and the user device 102.

In operation 204, process 200 receives entity information from the user device 102. In an embodiment, user device 102 may provide information about a specific entity to the SQOR system 110. The SQOR system 110 may use the entity information to generate and store one or more new records for the specific entity.

In operation 206, process 200 receives entity vertical information from the user device 102. In an embodiment, SQOR system 110 may receive, from the user device 102, current vertical information about the specific entity. The SQOR system 110 may use the vertical information to update the specific entity's records to reflect the received vertical information.

In operation 208, process 200 receives entity stage information from the user device 102. In an embodiment, SQOR system 110 may receive, from the user device 102, current entity stage information about the specific entity. The SQOR system 110 may use the entity stage information to update the specific entity's records to reflect the received stage information.

In operation 210, process 200 determines a set of software tools based on the entity vertical and entity stage assigned to the specific entity. In an embodiment, the SQOR system 110 determines the available software tools for the specific entity based upon the current entity vertical and entity stage assigned to the specific entity. For example, if the specific entity is assigned to the e-commerce vertical and initial seed stage, then the SQOR system 110 may recommend each software tool that for entities in the initial seed stage and in the e-commerce vertical.

In operation 212, process 200 verifies software tool integration with the entity. In an embodiment, software tool verification may include the SQOR system 110 connecting to external servers 150 to verify login credentials of the entity for each assigned software tool. Once the software tools are verified for integration, the SQOR system 110 may start to receive performance data, such as KPIs, from the external software tools 152.

In operation 214, process 200 retrieves performance data from the software tools. In an embodiment, SQOR system 110 connects to and retrieves available KPIs from the external software tools 152. The available KPIs may represent first-party data as it is data generated from the external software tools 152 running on the external servers 150.

In operation 216, process 200 calculates an entity execution score based on performance data from the software tools. In an embodiment, SQOR system 110 analyzes and aggregates the retrieved performance data to generate an entity execution score.

In operation 218, process 200 provides an entity execution score. In an embodiment, the SQOR system 110 may provide the entity execution score to the user device 102. The user device 102 may receive, from the SQOR system 110, a report that contains the entity execution score along with an explanation of the score. For instance, if the score is based on a 0-100 scale and the score provided by the SQOR system 110 is 87, then the accompanying report may define the 0-100 scale and provide additional details that describe how well the entity is performing based upon the calculated score of 87. Embodiments for generating and sending notification are described in the NOTIFICATION GENERATION section herein.

In operation 220, process 200 updates the entity execution score based on new performance data received from software tools. In an embodiment, the SQOR system 110 may be periodically receiving performance data from the external software tools 152. The SQOR system 110 may recalculate the entity execution score based upon the new performance data received. The SQOR system 110 may generate a new notification for user device 102 that includes an updated entity execution score. Additionally, the SQOR system 110 may include information that shows the change between the new entity execution score and the previously calculated entity execution score. The SQOR system 110 may also include trend information about the current trend of the entity execution score over multiple calculation cycles. For example, the trend of the entity execution score in the notification score may indicate that the sales department's conversion numbers have been steadily dropping by 3-5% in each of the last three quarters.

The presently disclosed arrangements may acquire company data from software tools, direct input from company staff, historical data, or any other variations known in the art.

The presently disclosed arrangements may be used by any type of customer, such as company founders, company employees, investors, or any other variations known in the art.

The execution score may be used for evaluating the fundability of a company, a company's ongoing health/success after funding, a company's potential when considering a buy-out, or any other variations known in the art.

The presently disclosed arrangements may be integrated into some or all divisions of a company including sales, marketing, finance, operations, customer success, product/engineering, or any other variations known in the art.

An execution score may be assigned at the company level, division level, individual SAAS tool level, or any other variations known in the art.

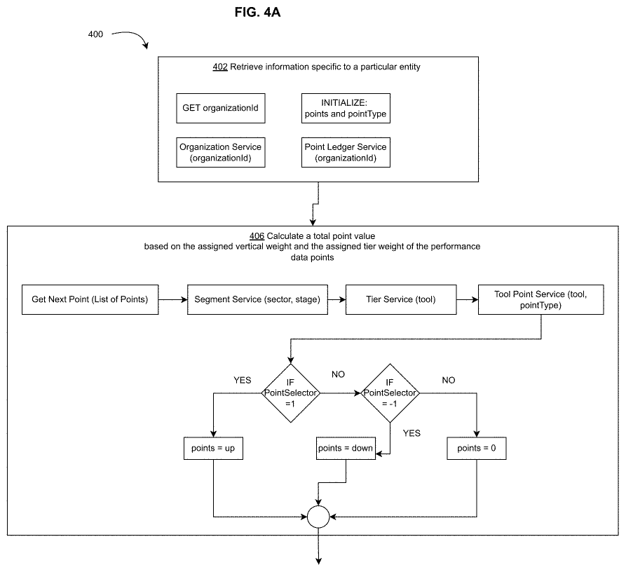

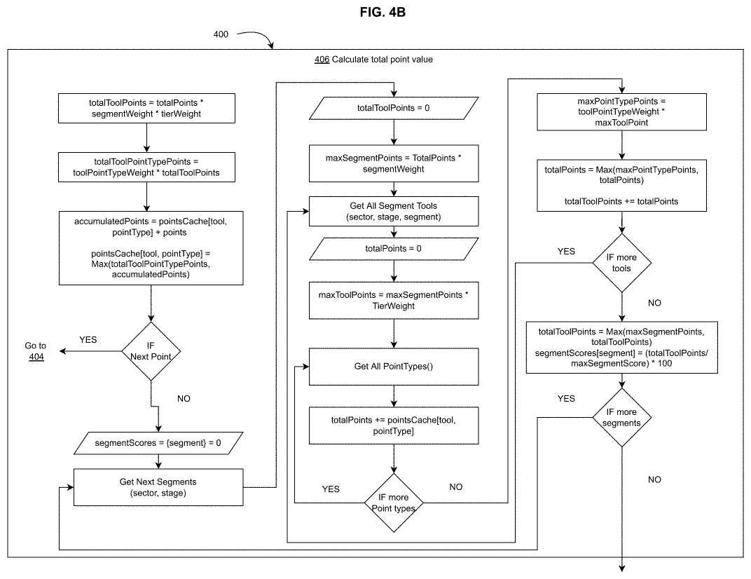

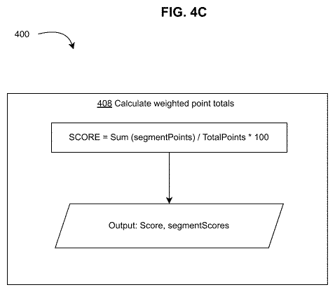

FIGS. 4A-4C depict another example flowchart depicting the SQOR system 110 calculating the entity execution score. Steps depicted in FIGS. 4A-4C may be performed by a single program or multiple programs. The steps of the process as shown in FIGS. 4A-4C may be implemented using processor-executable instructions that are stored in computer memory. For purposes of providing a clear example, the operations of process 400 are described as performed by the SQOR system 110.

In operation 402, process 400 retrieves information specific to the particular entity. In an embodiment, the SQOR system 110 retrieves information specific to the particular entity to be analyzed. The information may include stored entity information that the SQOR system 110 retrieves using function calls such as get organizationId, initialize points and pointType, initializing an Organization service, and initializing a PointLedger service.

In operation 404, process 400 iterates through each performance data point and determines the corresponding vertical (sector) and stage, tier assigned for the performance data point, and initializes the point type management service 126 to determine how to assign point values to each performance data point. In an embodiment, after the entity and the point ledger for the entity has been initialized, the SQOR system 110 iterates through each performance data point and determines the corresponding vertical (sector) and stage, tier assigned for the performance data point, and initializes the point type management service 126 to determine how to assign point values to each performance data point. For example, the point type management service 126 determines whether a performance data point indicates a good, bad, or neutral value, and increments, decrements, or keeps the same the point value for that particular performance data point.

In operation 406, process 400 calculates a total point value based on the assigned vertical weight and the assigned tier weight of the performance data points. In an embodiment, the total tool points are calculated by multiplying the total point value by the assigned vertical weight and the assigned tier weight for that particular performance data point. The total tool points are then multiplied by the point type weight in order to obtain a weighted point total for the performance data point. The SQOR system 110 repeats the calculation steps for each performance data point and then aggregates the weighted point totals. The SQOR system 110 maintains a maximum point total value for each group of performance data points and determines whether the aggregated weighted point total exceeds the assigned maximum value. If the aggregated weighted point total exceeds the assigned maximum value, then the maximum value is assigned as the aggregated weighted point total. If, however, the aggregated weighted point total does not exceed the assigned maximum value, then the aggregated weighted point total is kept as the aggregated weighted point total. Weighted point totals are calculated based on the performance data points grouped together for each division.

In operation 408, process 400 calculates weighted point totals. In an embodiment, upon calculating the weighted point totals, the SQOR system 110 calculates the entity execution score as:

$$Entity Execution Score = \frac{sum ( weighted point total )}{TotalPoints} * 100$$

where the weight point total represents the aggregated point values for performance data points for each division within the entity.

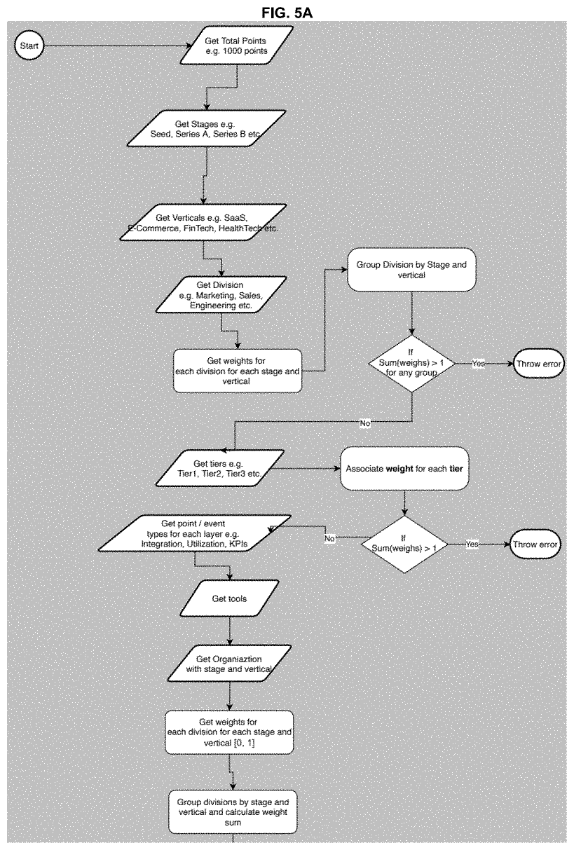

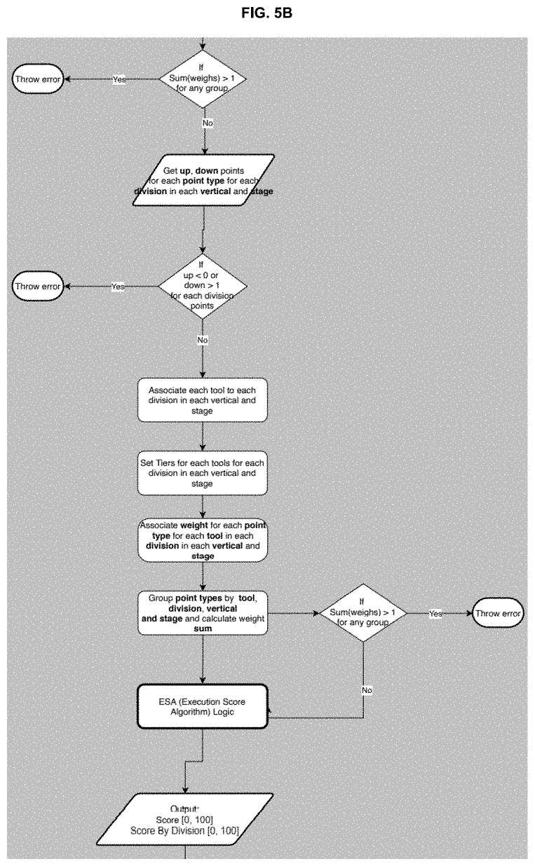

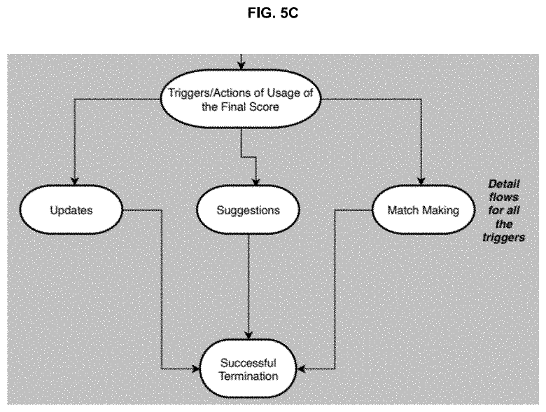

FIGS. 5A-5C represents another example flowchart depicting the SQOR system 110 initializing parameters and variables, calculating the entity execution score, and generating notifications for user devices. FIGS. 5A-5C contain steps indicating the process flow, including exception handling for errors when a weighted sum is greater than a defined threshold.

More specifically, FIG. 5C depicts downstream processing of the calculated entity execution score. In an embodiment, the SQOR system 110 may trigger and action based upon the entity execution score (depicted in FIG. 4C as the Final Score). The SQOR system 110 may trigger an update to the entity execution score based upon newly received performance data from external software tools 152. Alternatively, depending on the entity execution score, the SQOR system 110 may generate one or more notifications that contain one or more suggests for the user to do, in order to improve the entity execution score. For example, the suggestions may include finishing setup of various software tools that may have not been correctly or completely set up. In another example, the suggestions may include suggestions to add or remove software tools or to adjust entity processes in order to improve performance of one or more divisions of the entity. In yet another example, the SQOR system 110 may send notifications to other users, such as investors who may be interested in investing in the entity. In yet another example, the SQOR system 110 may add an entity, based on their entity execution score, to a candidate list of potential entities that are the top entity performers within a vertical.

### Notification Generation

The SQOR system 110 is implemented to generate notifications triggered by the calculation of the entity execution score and its corresponding value. In an embodiment, the entity execution score, depending upon the value, may trigger one or more notifications to one or more users. If the entity execution score is above or below a certain threshold, then a notification may be triggered and sent to one or more user devices 102-106. For example, if the entity execution score is below a “good quality” threshold, then the SQOR system 110 may generate a notification that is sent to user device 102, which may be used by an analyst. The notification may include information that indicates the health and quality of the entity, including individual scores calculated for each division within the entity.

In another embodiment, the SQOR system 110 may generate additional information in the notification that includes specific suggestions to improve the entity execution score. For example, the specific suggestions may include instructions on how the entity can more efficiently integrate their software tools in order to improve future entity execution scores.

In yet another embodiment, the SQOR system 110 may generate division specific notifications to alert users when a specific division's score drops below a certain threshold. For example, if the overall entity execution score is above a “Good Quality” threshold but the sales division's calculated score is below a “Bad Quality” threshold, then the SQOR system 110 may generate a division specific notification to inform users that the division is underperforming. The division specific notifications may be sent to user device 102, which is used by an analyst, user device 104, which is used by a user in the division that is underperforming, and user device 106, which may be used by any other interested user such as supervisor, vice president, or other interested investors.

In yet another embodiment, the SQOR system 110 may generate notifications that include future steps of tasks recommended to the entity based upon the entity's stage and vertical. For example, if the entity is about to start a new funding stage, then the SQOR system 110 may trigger a notification that includes a recommended task list to preparing to enter a new funding stage.

In yet another embodiment, the SQOR system 110 may send notifications to other interested parties, such as current or potential investors. For example, if the entity execution score is above a specific quality threshold, then the SQOR system 110 may send a notification to potential investors informing them of the high-quality execution score.

Additionally, the SQOR system 110 may trigger other events such as inserting the entity into a candidate pool for investment opportunities. The candidate pool may be provided to potential investors along with the entity execution scores for the candidate entities.

### Machine Learned Models

In an embodiment, one or more machine-learned models may be used to determine optimal quantitative weights for performance metrics based upon the software tool, the assigned division, vertical, and stage of a particular entity. The machine-learned models may be trained using historical calculated values for divisions of the particular entity over a period of time. Additionally, historical calculated values for other entities that have similar characteristics as the particular entity may be used to train the one or more machine-learned models. For example, the SQOR system 110 may retrieve entity execution values and division specific score values for the particular entity and provide the historical values to the machine-learned models to determine optimal quantitative weights for each of the performance metrics associated with the particular entity. The SQOR system 110 may then adjust the quantitative weights for each of the performance metrics for the particular entity and calculate a new entity execution score using retrieved performance data points the adjusted quantitative weights.

In another embodiment, one or more machine-learned models may be used to pre-compute an entity execution score for a new entity based upon how similar the new entity is to existing entities. For example, the one or more machine-learned models may receive as input the new entity and information describing the different divisions of the entity and the integrated software tools for that entity. The one or more machine-learned models may then determine a predictive entity execution score based upon historical entity execution scores previously calculated for entities that have similar divisions, verticals, and stages to the new entity.

The one or more machine-learned models described may implement several different machine-learning techniques including, but not limited to, a binary classification model, a logistic regression model, a multiclass classification model, a multinomial logistic regression model, a linear regression model, random forest, decision tree learning, association rule learning, artificial neural network, support vector machines, Bayesian networks, deep neural networks, convolution neural networks, recursive neural networks, classifiers, and other supervised or unsupervised machine learning algorithms.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

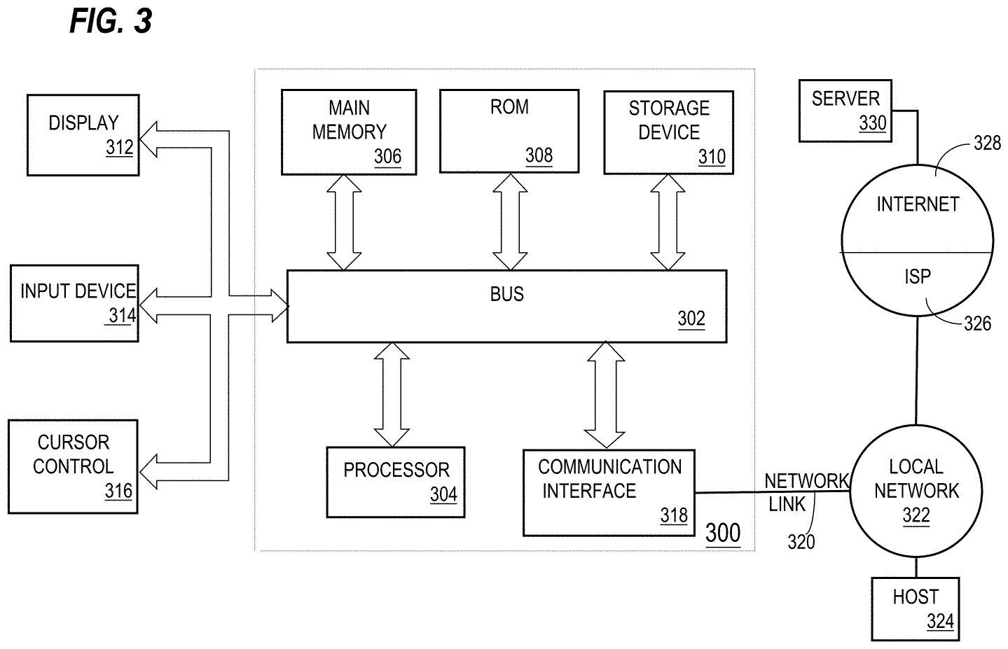

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method comprising:
maintaining, by a standard quantitative operations rating (SQOR) system on a server computer, one or more entities and their respective entity attributes;
determining, for a particular entity of the one or more entities, a set of software tools for integration with the entity;
verifying, by the SQOR system, that at least a subset of the set of software tools are integrated with the particular entity;
receiving, by the SQOR system, performance data from the subset of the set of software tools;
calculating, by the SQOR system, an entity execution score for the particular entity based on the performance data from the subset of the set of software tools; and
providing, by the SQOR system, the entity execution score to a user device.

2. The method of claim 1, wherein determining, for the particular entity of the one or more entities, the set of software tools for integration with the entity comprises, determining the set of software tools for integration with the entity based on the entity's vertical and the entity's stage.

3. The method of claim 1, further comprising:
for each data point of the performance data received, assigning a division of a set of divisions to a particular data point; and
grouping data points of performance data based on their assigned divisions to generate a set of division performance groups.

4. The method of claim 3, further comprising, for each division performance group in the set of division performance groups, assigning, by the SQOR system, a weight to each data point in the respective division performance group.

5. The method of claim 3, wherein calculating the entity execution score for the particular entity based on the performance data from the subset of the set of software tools, comprises:
assigning a score to each data point of the performance data based on a scoring rubric;
for each division performance group in the set of division performance groups, calculating a division score by aggregating scores assigned to each data point within a respective division performance group; and
aggregating the division scores of the divisions to generate the entity execution score for the particular entity.

6. The method of claim 5, wherein the scoring rubric incorporates the assigned weight of each respective data point.

7. The method of claim 1, further comprising:
comparing the entity execution score to a performance threshold;
upon determining that the entity execution score is above the performance threshold, generating a notification indicating that the entity is performing above the performance threshold.

8. The method of claim 7, further comprising:
upon determining that the entity execution score is below the performance threshold, comparing the entity execution score to a second performance threshold;
upon determining that the entity execution score is below the second performance threshold, generating a second notification indicating that the entity is underperforming based on the second performance threshold; and
wherein the second notification includes one or more performance suggestions for implementation to improve the entity's performance.

9. The method of claim 1, further comprising:
receiving, by the SQOR system, additional performance data from the subset of the set of software tools;
updating, by the SQOR system, the entity execution score for the particular entity based on the additional performance data; and
providing, by the SQOR system, the entity execution score to the user device.

10. The method of claim 1, wherein the at least a subset of the set of software tools comprises one or more software as a service (SaaS) tool.

11. A computer program product comprising:
one or more non-transitory computer-readable storage media comprising instructions which, when executed by one or more processors, cause:
maintaining, by a standard quantitative operations rating (SQOR) system on a server computer, one or more entities and their respective entity attributes;
determining, for a particular entity of the one or more entities, a set of software tools for integration with the entity;
verifying, by the SQOR system, that at least a subset of the set of software tools are integrated with the particular entity;
receiving, by the SQOR system, performance data from the subset of the set of software tools;
calculating, by the SQOR system, an entity execution score for the particular entity based on the performance data from the subset of the set of software tools; and
providing, by the SQOR system, the entity execution score to a user device.
